(19) United States
(12) Patent Application Publication
(10) Pub. No.: US 2023/0314071 A1
(43) Pub. Date: Oct. 5, 2023

(54) METHOD OF MANUFACTURING SEALED BATTERY

(71) Applicant: Prime Planet Energy & Solutions, Inc., Tokyo (JP)

(72) Inventor: Yuzo SUZUKI, Kariya-shi (JP)

(21) Appl. No.: 18/191,871

(22) Filed: Mar. 29, 2023

(30) Foreign Application Priority Data
Mar. 30, 2022 (JP) 2022-056413

(51) Int. Cl. F26B 9/06; H01M 10/058

(52) U.S. Cl. CPC F26B 9/06; H01M 10/058; F26B 21/10

(57) ABSTRACT

The present disclosure provides a method of manufacturing a sealed battery, by which battery assemblies can be dried properly even when the time for the drying is reduced. The manufacturing method disclosed herein includes: loading, in a drying oven, a placing table with a battery assembly placed thereon in a drying oven, the battery assembly housing an electrode body inside a case; drying by increasing a temperature of the battery assembly in the drying oven to remove moisture inside the case; and cooling the battery assembly. In the manufacturing method disclosed herein, the warming member is placed on the placing table. This allows the battery assemblies to be properly dried even when the time for the drying is reduced.

### CROSS REFERENCE TO RELATED APPLICATIONS

This application claims the benefit of priority to Japanese Patent Application No. 2022-056413 filed on Mar. 30, 2022. The entire contents of this application are hereby incorporated herein by reference.

### BACKGROUND OF THE DISCLOSURE

### 1. Technical Field

The present disclosure relates to a method of manufacturing a sealed battery.

### 2. Description of the Related Art

Sealed batteries such as lithium-ion secondary batteries and nickel hydride batteries are becoming increasingly important as power sources for vehicles or for personal computers and mobile terminals. These sealed batteries are manufactured, for example, by constructing a battery assembly with an electrode body housed in a case, injecting an electrolyte inside the battery assembly, and then sealing the case.

If the case (especially inside the electrode body) of the sealed battery contains a large amount of moisture after manufacturing, gas will be generated during charging, which causes a decrease in battery performance. Thus, in manufacturing of sealed batteries, the battery assembly before injection of the electrolyte is dried to remove the moisture inside the case. JP 2016-81758A and JP 2018-98012A show examples of technologies relating to this kind of drying.

### SUMMARY

In order to reliably dry the inside of the case of the battery assembly in the drying above-mentioned, it has been necessary to set a very long drying time. Therefore, the drying is considered to be one of the factors that reduce the manufacturing efficiency of sealed batteries, and a technology by which battery assemblies can be properly dried even when the time for the drying is reduced has been desired.

In order to achieve the objective, the present disclosure provides a method of manufacturing a sealed battery with the following configuration (hereinafter also referred to as “the manufacturing method”).

The manufacturing method disclosed herein includes: loading a placing table with a battery assembly placed thereon in a drying oven, the battery assembly housing an electrode body inside a case; drying by increasing a temperature of the battery assembly in the drying oven to remove moisture inside the case; and cooling the battery assembly. In the manufacturing method disclosed herein, the warming member is placed on the placing table.

In the manufacturing method with such a configuration, the battery assembly and the warming member are placed on the placing table. In this state, the placing table is loaded in the drying oven, and the drying is performed. Heat from the drying oven is held in the warming member placed close to the battery assembly. This allows efficient hating of the battery assembly. Accordingly, the battery assembly can be properly dried even when the time for the drying is reduced.

In a preferred aspect of the manufacturing method disclosed herein, the drying oven includes: a perimeter wall surrounding the placing table; and a heater attached to at least a portion of the perimeter wall, and the warming member is placed in an outer edge portion of the placing table so as to face a portion of the perimeter wall where the heater is not attached, among the perimeter wall adjacent to the placing table. With such a configuration, the warming member holds heat from the drying oven. Thus, a temperature drop in the vicinity of a portion where the heater is not attached is substantially prevented. Accordingly, a temperature distribution in the drying becomes uniform, and the battery assembly can be dried more efficiently.

In a preferred aspect of the manufacturing method disclosed herein, as the warming member, a metal block body or a ceramic block body is used. With such a configuration, the battery assembly can be heated more efficiently.

In a preferred aspect of the manufacturing method disclosed herein, the metal block body contains stainless steel or aluminum.

In a preferred aspect of the manufacturing method disclosed herein, air is blown from a direction in which the warming member is not installed. With such a configuration, the battery assembly can be efficiently cooled in the cooling after the drying. Accordingly, the manufacturing efficiency of the battery assembly can be further improved.

In a preferred aspect of the manufacturing method disclosed herein, in the loading, multiple placing tables stacked in a height direction are loaded in the drying oven, and among the placing tables, positions at which the warming members are placed are substantially the same in plan view. This allows each of a large number of battery assemblies placed on multiple placing tables to be dried efficiently.

### BRIEF DESCRIPTION OF THE DRAWINGS

FIG. 1 is a flowchart illustrating processes of the manufacturing method according to an embodiment.

FIG. 2 is a schematic perspective view of a placing table (a support is not shown) in the manufacturing method according to the embodiment.

FIG. 3 is a schematic transverse sectional view of the state where the placing table in the manufacturing method according to the embodiment is housed in a drying oven.

FIG. 4 is a longitudinal cross-sectional view of the state where the placing table in the manufacturing method according to the embodiment is housed in a drying oven.

### DETAILED DESCRIPTION

An embodiment of the technology disclosed herein will be described below with reference to the accompanying drawings. The matters necessary for executing the present disclosure, which is not mentioned herein, can be grasped as design matters of those skilled in the art based on the related art in the preset field. The present disclosure can be executed based on the contents disclosed herein and the technical knowledge in the present field. In the following drawings, the same members/portions which exhibit the same action are denoted by the same reference numeral. The dimensional relation (such as length, width, or thickness) in each drawing does not reflect the actual dimensional relation.

The “sealed battery” herein indicates a battery cell housing an electrode body and electrolyte in a case. The sealed battery is not limited to a primary battery or a secondary battery, and various types of known battery cells is widely applicable. The “secondary battery” herein indicates an electricity storage device that can be repeatedly charged and discharged, and encompasses so-called secondary batteries and electricity storage elements such as electric double-layer capacitors. Such a secondary battery can be, for example, a lithium-ion secondary battery using lithium ions as charge carriers. The “battery assembly” herein is a structure (i.e., a battery before injection of electrolyte) that has been assembled to a form prior to injection of electrolyte in manufacturing processes of the sealed battery.

1. Method of Manufacturing Sealed Battery

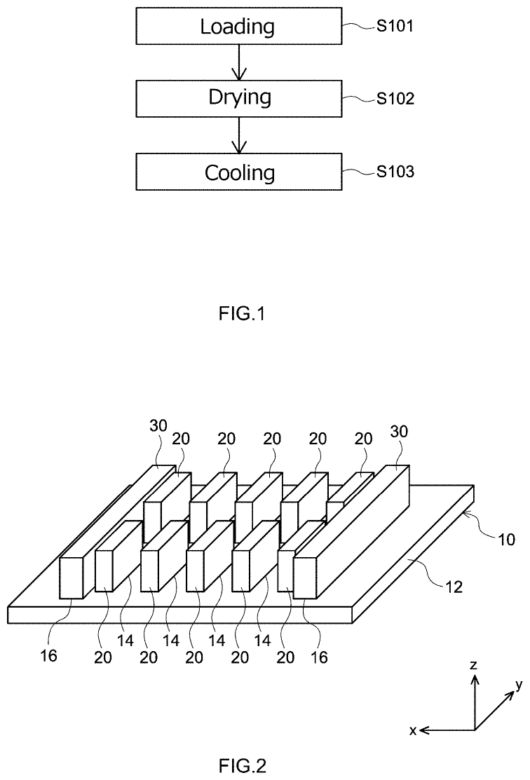

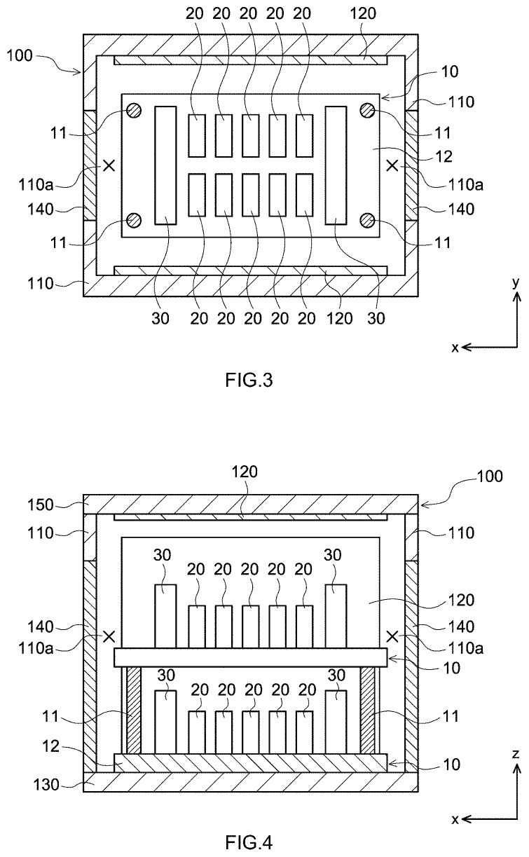

A preferred embodiment of the method of manufacturing a sealed battery disclosed herein will be described below. FIG. 1 is a flowchart diagram illustrating processes of the manufacturing method according to the embodiment. FIG. 2 is a schematic perspective view of a placing table in the manufacturing method according to the embodiment. FIG. 3 is a schematic transverse sectional view of the state where the placing table in the manufacturing method according to the embodiment is housed in a drying oven. FIG. 4 is a longitudinal cross-sectional view of the state where the placing table in the manufacturing method according to the embodiment is housed in a drying oven. In FIGS. 2 to 4, the reference X indicates the width direction, and the reference y indicates the depth direction, and the reference z indicates the height direction.

As shown in FIG. 1, the method of manufacturing a sealed battery according to the embodiment includes: loading S101, drying S102, and cooling S103. Each process will be described below.

(1) Loading S101

In the loading S101, as shown in FIG. 3, a placing table 10 with battery assemblies 20 placed thereon is loaded in a drying oven 100. Each component used in the present embodiment will be described below.

Each of the battery assemblies 20 is, as mentioned above, a structure that has been assembled to a form prior to injection of an electrolyte in the processes of manufacturing a sealed battery. Although not shown in the drawings, the battery assembly 20 has a configuration where an electrode body is housed inside a battery case. For example, the battery assembly 20 shown in FIG. 2 uses a substantially cuboid battery case. The battery case houses therein an electrode body including a positive electrode and a negative electrode. An inlet through which the electrolyte is injected is provided in a surface (e.g., the top surface) of the battery case. In other words, the battery assembly 20 has a configuration where the inside and outside of the battery case communicate with each other via the inlet. The battery assembly 20 needs to be placed on the placing table 10 and housed in a drying oven 100, but specific materials and structure of the battery assembly 20 are not particularly limited. For example, the outside shape of the battery assembly 20 is not limited to a substantially cuboid shape such as shown in FIG. 2, and may be a cylindrical shape.

Next, the placing table 10 is a member on which the battery assemblies 20 are placed. The structure of the placing table 10 is also not particularly limited, and in the present disclosure, a known placing table which can be used for transportation and storage of battery assemblies or sealed batteries can be used. The placing table 10 preferably includes a substrate 12, battery holders 14, and warming member holders 16 as shown in FIG. 2, for example. Specifically, the substrate 12 is a plate-like member having a substantially rectangular shape in plan view. On the upper surface of the substrate 12, battery assemblies 20 and warming members 30 to be described later are placed. Next, the battery holders 14 hold the battery assemblies 20 placed on the substrate 12. This substantially prevents displacement of the battery assemblies 20 during transportation thereof on the placing table 10. Note that the battery holders 14 shown in FIG. 2 are rectangular recesses provided in the upper surface of the substrate 12. The battery assemblies 20 fit into the battery holders 14, thereby holding the battery assemblies 20. However, the configuration of the battery holders 14 are not limited thereto, and the battery holders 14 may be a member for holding the battery assemblies 20 by sandwiching. The warming member holders 16 are members for holding the warming members 30 placed on the substrate 12. This substantially prevents displacement of the warming members 30. Similarly to the battery holders 14, the structure of each of the warming member holders 16 is not limited. The warming member holders 16 may be recesses into which the warming members 30 such as shown in FIG. 2 fit, or may be members for holding the warming members 30 by sandwiching.

In the present embodiment, the warming members 30 are placed on the placing table 10. As will be described in detail later, this allows the battery assemblies 20 to be properly dried even when the time for the drying is reduced.

As each of the warming members 30, a metal block body, a ceramic block body, or the like is preferably used. Temperatures of such block bodies containing inorganic materials easily increase by heat from the drying oven 100. Thus, the battery assemblies 20 on the placing table 10 can be efficiently heated. Examples of the metal material contained in the block body include stainless steel and aluminum. The warming member 30 containing these metal materials is relatively inexpensive, which is preferable.

The shape and dimensions of the warming member 30 can be changed, as appropriate, according to the shapes and dimensions of the placing table 10 and the battery assemblies 20, and are not factors limiting the technology disclosed herein. For example, the warming member 30 shown in FIG. 2 is a substantially cuboid member extending along the depth direction y. The dimension of the warming member 30 in the depth direction y is preferably set such that the battery assembly 20 placed on the placing table 10 can be covered in side view. For example, in FIG. 2, two battery assemblies 20 are arranged in the depth direction y. In this case, the dimension of the warming member 30 in the depth direction y is preferably longer than the total dimension of the two battery assemblies 20 in the depth direction y. This allows efficient heating of each of the battery assemblies 20. Further, the height of the warming member 30 (the dimension in the height direction z) is preferably equal to or higher than the height of the battery assembly 20. This allows efficient heating of each of the battery assemblies 20.

The drying oven 100 only needs to house the placing table 10 and dry the battery assemblies 20 on the placing table 10. Thus, the known drying oven can be used without particular limitations. For example, the drying oven 100 shown in FIGS. 3 and 4 includes a perimeter wall 110 surrounding the placing table 10 and a heater 120 attached to at least part of the perimeter wall 110. Specifically, as shown in FIG. 4, the drying oven 100 further includes a floorboard 130 on which the placing table 10 is to be placed. The material of the floorboard 130 only needs to have strength with which the placing table 10 can be supported, and is not particularly limited. The perimeter wall 110 of the drying oven 100 is configured to stand upward in the height direction z from the peripheral edge of the floorboard 130. The upper end of the perimeter wall 110 is provided with a ceiling portion 150, which forms the ceiling of the drying oven 100. In addition, at least a portion of the peripheral wall 110 is provided with openings 110a for loading and unloading the placing table 10. In the drying oven 100 shown in FIGS. 3 and 4, a pair of openings 110a is provided on both sides of the perimeter wall 110 in the width direction x. One of the openings 110a in pair serves as a loading path for loading the placing table 10, and the other serves as an unloading path for unloading the placing table 10. Each of the openings 110a in the perimeter wall 110 is provided with a shutter 140 which can be opened and closed. The shutter 140 is opened when the placing table 10 is loaded or unloaded, and is closed when the drying is performed. Further, in the drying oven 100 shown in FIGS. 3 and 4, a portion of the perimeter wall 110 where the shutters 140 are not attached and the ceiling portion 150 are provided with heaters 120. Although not shown in the drawings, in the drying oven 100 of the present embodiment, the ceiling portion 150 is provided with a fan. The fan functions to facilitate heat circulation in the drying oven 100 in the drying to be described later.

The means for loading and unloading the placing table 10 to the drying oven 100 is not particularly limited. A means for automatically loading and unloading the placing table 10 can be, for example, transportation by a belt conveyer, a push-out mechanism, or robot arms. However, the placing table 10 may be loaded or unloaded manually without using the above-mentioned means.

(2) Drying S102

In this process, the battery assemblies 20 are heated up in the drying oven 100 to remove moisture from the inside of the case. In detail, first, the placing table 10 is housed in the drying oven 100, and the shutter 140 is then closed to seal the drying oven 100. In this state, the heater 120 is operated to heat up the battery assemblies 20. Accordingly, moisture adhered to the case of the battery assemblies 20 is removed. In the manufacturing method according to the present embodiment, the warming members 30 are placed on the placing table 10. When the temperature inside the drying oven 100 is increased in this state, the heat from the heater 120 is retained in the warming members 30. Accordingly, the battery assemblies 20 close to the warming members 30 can be efficiently heated, whereby the battery assemblies 20 can be properly dried even when the time for the drying is reduced.

The drying conditions in this process do not limit the technology disclosed herein, and can be controlled, as appropriate, according to factors such as the sizes of the battery assemblies 20 and the number of battery assemblies 20 on the placing table 10. For example, the drying temperature is preferably 110° C. to 140° C. The drying temperatures in this range allow suitable removal of moisture while substantially preventing deterioration of a resin member used in the battery assemblies 20.

In this process, the inside of the drying oven 100 may be depressurized after increasing the temperature inside the drying oven 100 to a predetermined temperature. This allows proper removal of moisture in the case of the battery assemblies 20 even when the drying temperature is set low. Therefore, deterioration of the resin member can be more suitably prevented. When the inside of the drying oven 100 is depressurized, an effect of reducing the time for the drying is exhibited. As an example, the pressure inside the drying oven for depressurizing is preferably 1 kPa or less, more preferably 500 Pa or less.

Further, as mentioned above, according to the manufacturing method according to the present embodiment, the battery assemblies 20 can be properly dried even when the time for the drying S102 is reduced. Although not intended to limit the technology disclosed herein, this embodiment allows the battery assemblies 20 to be dried properly even when the drying time is reduced to 1 hour to 1.5 hours, which in the conventional technology needed to be set to 1.5 hours to 2 hours.

(3) Cooling S103

In this process, the battery assemblies 20 after being dried are cooled. The means for cooling the battery assemblies 20 is not particularly limited. The method can be, for example, a method in which the placing table 10 is taken out from the drying oven 100 and the battery assemblies 20 are naturally cooled at room temperature. Alternately, the temperature of the inside of the drying oven 100 may be reduced while the drying oven 100 houses the placing table 10, thereby cooling the battery assemblies 20. Other examples of the means for cooling include cooling by blowing air, cooling in a temperature-controlled thermostatic chamber, and ice cooling. Among them, cooling by blowing air is preferable. At this time, the air blowing is performed preferably along the direction in which the warming members 30 are not placed (the depth direction y in FIG. 2). This allows efficient cooling of each of the battery assemblies 20.

The manufacturing method according to the embodiment has been described above. As mentioned above, in the manufacturing method according to the present embodiment, the warming members 30 are placed on the placing table 10. This allows the battery assemblies 20 to be properly dried even when the time for the drying is reduced.

After the cooling S103 mentioned above, injecting of injecting an electrolyte into the battery assemblies 20, sealing of sealing the inlets of the battery assemblies 20, and the like are performed. Accordingly, a sealed battery housing electrode bodies and an electrolyte are housed in a case is manufactured. According to the manufacturing method according of the present embodiment, moisture inside the battery assemblies 20 has been sufficiently removed before injection of the electrolyte. Thus, the performance of the sealed battery can be properly prevented.

2. Placement of Warming Member

Next, the positions at which the warming members 30 are placed when the drying S102 is performed with be described below. It is preferable that the positions at which the warming members 30 are placed are controlled, as appropriate from the viewpoint of efficiently heating the battery assemblies 20, taking into consideration that the structure of the drying oven 100, the positions at which the battery assemblies 20 are placed, and the like.

For example, the warming members 30 are placed in an outer edge portion of the placing table 10 so as to face portions of the perimeter wall 110 where the heaters 120 are not attached, among the perimeter wall 110 of the drying oven 100 adjacent to the placing table 10. Specifically, as shown in FIGS. 3 and 4, a shutter 140 is attached to the perimeter wall 110 having an opening 110a in the drying oven 100. It is difficult to install heaters in areas where moving parts such as this shutter 140 are installed in terms of operation space. It is also possible that heaters may not be installed on some areas of the perimeter wall of the drying oven in terms of reducing equipment costs and the like. In such a drying oven 100, the temperature of the area in the vicinity of the heater 120 is high, and the temperature of the area in the vicinity of the perimeter wall 110 (the shutter 140 in FIGS. 3 and 4), where the heater 120 is not attached is low. Such an uneven temperature distribution occurred in the drying oven 100 makes it difficult to dry the battery assemblies 20 placed in a low temperature region. In such a case, the drying time needs to be set based on the battery assemblies 20 placed in the low temperature region, which may case the drying time to increase. In contrast, as shown in FIGS. 3 and 4, in the case where the warming members 30 are installed so as to face portions of the perimeter wall 110 where the heaters 120 are not attached, the warming members 30 hold heat. Thus, a temperature drop in the vicinity of portions where the heaters 120 are not attached is substantially prevented. Accordingly, a temperature distribution in the drying oven 100 becomes uniform, and the battery assemblies 20 can be dried more efficiently.

As shown in FIG. 4, multiple placing tables 10 stacked in the height direction z may be loaded in the drying oven 100. Specifically, as shown in FIG. 4, in the case where a substantially rectangular plate-like placing table 10 is used, a support 11 may be placed at each of four corners of the placing table 10 so as to stand upward in the height direction z, and another placing table 10 may be placed on the support 11. This allows the number of battery assemblies 20 which can be dried simultaneously to be increased, thereby further improving the efficiency of the drying process. In the case where such multi-level stacking of the placing tables 10 is performed, the positions where the warming members 30 are placed are made substantially the same in plan view among the placing tables 10. This allows uneven temperature distribution on the plane of each of the placing tables 10 to be substantially prevented, thereby efficiently drying a large number of battery assemblies 20. The shape and material of the support 11 are not particularly limited, and are not particularly restricted as long as the support 11 can withstand the temperature environment in the drying step and multi-level stacking. For example, the material of the support 11 may be the same as that of the warming member 30. This causes the support 11 to further function as the warming member, thereby drying the battery assemblies 20 more suitably.

Although the embodiment of the manufacturing method discloses herein has been described in detail above, it is a mere example and does not limit the appended claims. The technology described is the appended claims include various modifications and changes of the foregoing specific example.

What is claimed is:

1. A method of manufacturing a sealed battery, the method comprising:
Loading, in a drying oven, a placing table with a battery assembly placed thereon, the battery assembly housing an electrode body inside a case;
drying by increasing a temperature of the battery assembly in the drying oven to remove moisture inside the case; and
cooling the battery assembly, wherein
a warming member is placed on the placing table.

2. The method according to claim 1, wherein
the drying oven includes:
a perimeter wall surrounding the placing table; and
a heater attached to at least a portion of the perimeter wall, and
the warming member is placed in an outer edge portion of the placing table so as to face a portion of the perimeter wall where the heater is not attached, among the perimeter wall adjacent to the placing table.

3. The method according to claim 1, wherein
as the warming member, a metal block body or a ceramic block body is used.

4. The method according to claim 3, wherein the metal block body contains stainless steel or aluminum.

5. The method according to claim 1, wherein in the cooling, air is blown from a direction in which the warming member is not placed.

6. The method according to claim 1, wherein
in the loading, multiple placing tables stacked in a height direction are loaded in the drying oven, and
among the placing tables, positions at which the warming members are placed in plan view are substantially the same.
